(19) United States
(12) Patent Application Publication
(10) Pub. No.: US 2014/0358342 A1
(43) Pub. Date: Dec. 4, 2014

(54) SYSTEMS AND METHODS FOR PHOTOVOLTAIC VEHICLE OPERATION

(71) Applicant: E-Car Solar LLC, Laguna Beach, CA (US)

(72) Inventor: John Marks, Laguna Beach, CA (US)

(73) Assignee: E-CAR SOLAR LLC, Laguna Beach, CA (US)

(21) Appl. No.: 14/287,793

(22) Filed: May 27, 2014

Related U.S. Application Data
(63) Continuation-in-part of application No. 29/456,624, filed on May 31, 2013, now Pat. No. D707623.

(51) Int. Cl. B60L 8/00; B60K 16/00

(52) U.S. Cl. CPC B60L 8/003; B60K 16/00; B60K 2016/003
USPC 701/22; 180/2.2

(57) ABSTRACT

The invention provides an electrical vehicle power system that compares power use to anticipated need and regulates power use so that the anticipated need is satisfied by available power, thus ensuring ample power for a user to complete an activity such as playing a round of golf. The system uses a controller coupled to a photovoltaic cell on a golf car in a lightweight and durable solar roof apparatus that can retrofit to existing cars.

### CROSS-REFERENCE TO RELATED APPLICATION

This application is a continuation-in-part of U.S. application Ser. No. 29/456,624, filed May 31, 2013, the contents of which are incorporated by reference.

### FIELD OF THE INVENTION

The invention relates to management and use of solar power for golf cars at a golf course.

### BACKGROUND

Golfers dislike being stranded by a golf car that stops working unexpectedly. This causes employees of the facility (who are typically busy doing other things) to have to find a fully charged car and tow it out with another charged car to the place where the customers are abandoned. Pace of play on the golf course is stopped during this process backing up golfers for many holes. Then all the items in the dead car are needed to be transferred to the charged car (if the course even has one available) and the dead car is towed back the charging barn. Since golf courses are businesses that will not succeed if they create misery for their customers, they will not adopt golf cars that cease to work out on the course. This reluctance is in tension with increasing consumer demand for environmentally friendly products and services that do not burn through fossil fuels and pollute the air.

U.S. Pub. 2011/0210693 to Reichart reports a method of powering a golf car with solar energy and claims to provide 9 hours of power to a golf car. Unfortunately, this method only provides 200 watts and requires unstated assumptions to be true—that there will be no other drain on the power supply, that the golf course is of typical size with no remarkable hills or other features that would tax the motor, and that management will carefully log charging times and always provide every golfer with a fully charged car.

U.S. Pub. 2013/0335002 to Moore and U.S. Pat. No. 5,725,062 to Fronek report solar vehicles but neither makes any provision for ensuring adequate power to play 18 holes. Golf courses may not adopt the reported vehicles and methods since their circumstances may cause those vehicles to run out of power and stop working unexpectedly, leaving unhappy golfers, far from the parking lot and club house, stranded in the sun their heavy golf bags with until a fresh cart arrives, at a tremendous cost to the facility.

### SUMMARY

The invention provides an electrical vehicle power system that compares power use to anticipated need and regulates power use so that the anticipated need is satisfied by available power, thus ensuring ample power for a user to complete an activity such as playing a round of golf. The system uses a controller coupled to a photovoltaic cell on a golf car in a lightweight and durable solar roof apparatus that can retrofit to existing carts. The golf car is provided for use at a specific golf course and the controller uses information about power demands unique to that golf course to regulate power to the motor to ensure that the golf car completes a round of golf. Since the system is frugal with electricity only when it needs to be—e.g., on cloudy days or at golf courses with many steep hills to climb—the golf car can make surplus electricity available at times, which can be used for powering personal electronic devices or even can be fed back into the grid. The invention may include infrastructure installed at a golf course to manage electricity for numerous golf cars. Since each cart has a photovoltaic cell and a power controller that can use a power demand map unique to that golf course, the carts will not strand golfers out on the course and will even supply surplus power back into the system when available. Furthermore, through use of the solar roof apparatus, a golf course can retrofit their fleet of carts to minimize their energy costs and even sell power back to the utility commission without having to purchase an entire new fleet. This additionally allows the facility to purchase more cars to service customers. Thus systems and methods of the invention may provide considerable savings to a golf course in energy bills and will provide golfers with reliable carts that do not leave them stranded. Moreover, consumer sensitivity to environmental considerations is a driver of loyalty. Since a golf course will save on its energy bills while also retaining and growing a base of satisfied customers, systems and methods of the invention provide significant long-term improvements to the bottom line for a golf course.

In certain aspects, the invention provides a golf car power system that includes a golf car made available for use at a golf course, a photovoltaic cell mounted on the golf car (preferably integrated into the roof the car), and a controller system. The controller system includes a power management device electrically coupled to the cell and a processor coupled to a non-transitory memory and optionally having stored therein information about power required for the golf car to operate for a duration of a round of golf at the golf course.

Preferably the controller system is operable to compare present power use to the information about the power required and regulate the motor so that an amount of power remaining is at least as great as an anticipated amount of power required to complete the round of golf. The power management device may include a maximum power point tracking device, and regulating the motor can be done by limiting a maximum speed of the golf car.

The information about the power required can use an average distance travelled per typical round of golf. Present power use may be determined by tracking cumulative distance traveled in the round of golf at the golf course. The connection with the external power system can provide power from the external system to the golf car and provide power from the golf car to the external system.

In some embodiments, the controller system has a communication device operable to exchange data about the power system with a system management server computer. The system can include an “electricity gas gauge”—a display visible to a driver of the golf car that shows an amount of power remaining. The system may include a positioning device (e.g., a GPS device or barcodes and readers on the course) on the golf car to provide information to the controller system showing a present location of the golf car. The system may include the locationing system described in U.S. Pub. 2004/0243262 to Hofmann, the contents of which are incorporated by reference.

In a preferred embodiment, the information about the power required stored in the controller system includes a digital map of the golf course. The cart includes, in computer memory, a map. Map can mean a digital representation of a spatial layout of the course, or it can mean a recorded plan of distances to be traveled optionally with heights to be ascended along golf car paths during a round of golf for that course (e.g., an elevation change map for the golf car route for that course). The system can include maps for different courses, with the appropriate map being called into use at any given course. Thus, in certain embodiments, the controller system has stored therein a plurality of maps of different golf courses that includes a map that represents the golf course, wherein the information about the power required indicates which map represents the golf course.

The power system may include a power jack on the golf car for providing power to a personal electronic device. Thus a golfer may charge their smartphone or use their tablet computer in the cart. Additionally or alternatively, the system may include a connection point for making a connection with an external power system.

Aspects of the invention include a power management method for a golf car. Power for a golf car is obtained during a round of golf at a predetermined golf course through the use of a photovoltaic power system on the golf car. The method includes tracking a distance driven by the golf car during the round of golf, comparing the tracked distance to an average total distance associated with the predetermined golf course using the power system on the golf car; and regulating power consumption of the golf car, using the power system, so that the golf car will not run out of power until it has driven the average total distance. Preferably, the power system comprises one or more of a photovoltaic cell, a battery, a motor, a maximum point power tracking device, a processor, and a non-tangible computer-readable storage medium having stored therein information about the predetermined golf course. Surplus power may be provided from the golf car to a local grid at the predetermined golf course. The method includes displaying an amount of power remaining to a driver of the golf car via a display gauge.

In certain aspects, the invention provides a power management system for a golf course. The system includes a local electrical grid system installed at a golf course, which local grid has at least one connection to an external municipal power system, at least one battery system, and at least one charging station. The system includes golf cars that each have a photovoltaic cell and a jack connectable to the charging station. A system management server computer monitors power consumption in the golf cars. Each golf car captures power via its photovoltaic cell, provides surplus power to the at least one power system such as a battery or other storage device at a time when it is connected to the charging station and fully charged, and draws power from the at least battery system at a time when it is connected to the charging station and not fully charged. In some embodiments, each golf car has a controller system that includes a power management device electrically coupled to the cell; a processor; and a memory device having stored therein information unique to the golf course. The controller system uses the information unique to the golf course to regulate power use so that the golf car is operable for a duration of a round of golf on the golf course. The local electrical grid system may be operable to provide surplus local grid power to the external municipal power system with the server computer providing a statement of an amount of surplus local grid power provided to the external municipal power system.

Within the system, preferably each golf car includes a controller system with a power management device, a computer having stored therein information unique to the golf course, and a display showing power remaining The controller system uses the information unique to the golf course and the power remaining to modulate power consumption.

Other aspects of the invention provide a solar apparatus for a golf car. The apparatus is a solar roof installable onto a golf car. It includes a roof member with support legs for connection to a golf car, a photovoltaic cell at a top surface of the roof member, and a connection jack to electrically connect the photovoltaic cell to an electrical system of the golf car. The solar apparatus may include other features such as rain gutters to direct rain away from the photovoltaic cell and occupants of the golf car. In some embodiments, the support legs are configured to mate to pre-determined mounting points of a specified model of golf car. The apparatus may have a built-in maximum power point tracking device installed within the apparatus between the photovoltaic cell and the connection jack. The apparatus can include an “electricity gas gauge”—a gauge disposed on the apparatus and configured to be visible to a driver of the golf car when the apparatus is installed on the golf car. The gauge displays information about electrical power available to the golf car.

In certain embodiments, the apparatus will include a meter device configured to measure a distance that the golf car has been driven. Other possible features include a USB port to provide electricity to a device when the device is plugged into the USB port, an external jack for making a connection to a charging station (to provide and receive electrical power through the connection), or both. The apparatus may include a processing unit having stored therein information unique to at least one predetermined golf course and operable to limit output of a motor on the cart if the cart's usage at full speed will exceed an available amount of energy.

### BRIEF DESCRIPTION OF THE DRAWINGS

FIG. 1 depicts a golf car power system.

FIG. 2 depicts a roof member for a solar golf car.

FIG. 3 is a cross section along a roof member.

FIG. 4 is a cross section across a roof member.

FIG. 5 is a diagram of components of a controller system.

FIG. 6 diagrams a method for managing power of a golf car.

FIG. 7 depicts a map of a predetermined golf course.

FIG. 8 shows a power management system for a golf course.

FIG. 9 shows a device for displaying an amount of power remaining

FIG. 10 illustrates a method of managing power at a golf course.

FIG. 11 illustrates an interface to a golf course power management system.

FIG. 12 shows a photovoltaic roof assembly of the invention on a golf car according to certain embodiments.

### DETAILED DESCRIPTION

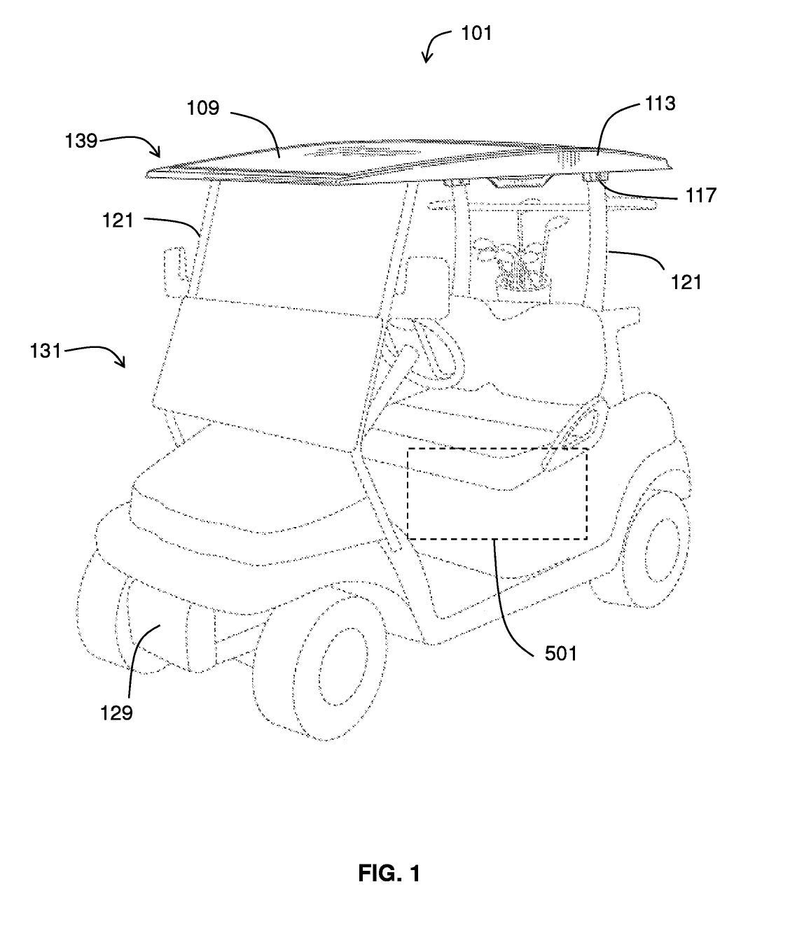

FIG. 1 depicts a golf car power system 101. System 101 includes a golf car 131 made available for use at a golf course, a photovoltaic cell 109 mounted on a roof member 113 of the golf car supported by uprights 121, a motor 129 to drive golf car 131, and a controller system 501. Controller system 501 includes a power management device electrically coupled to the cell 109. Roof member 113 with cell 109 defines a solar apparatus 139 for golf car that may be provided as a standalone apparatus 139 (optionally with or without support uprights 121 connected via support bosses 117). Apparatus 139 is a solar roof installable onto golf car 131.

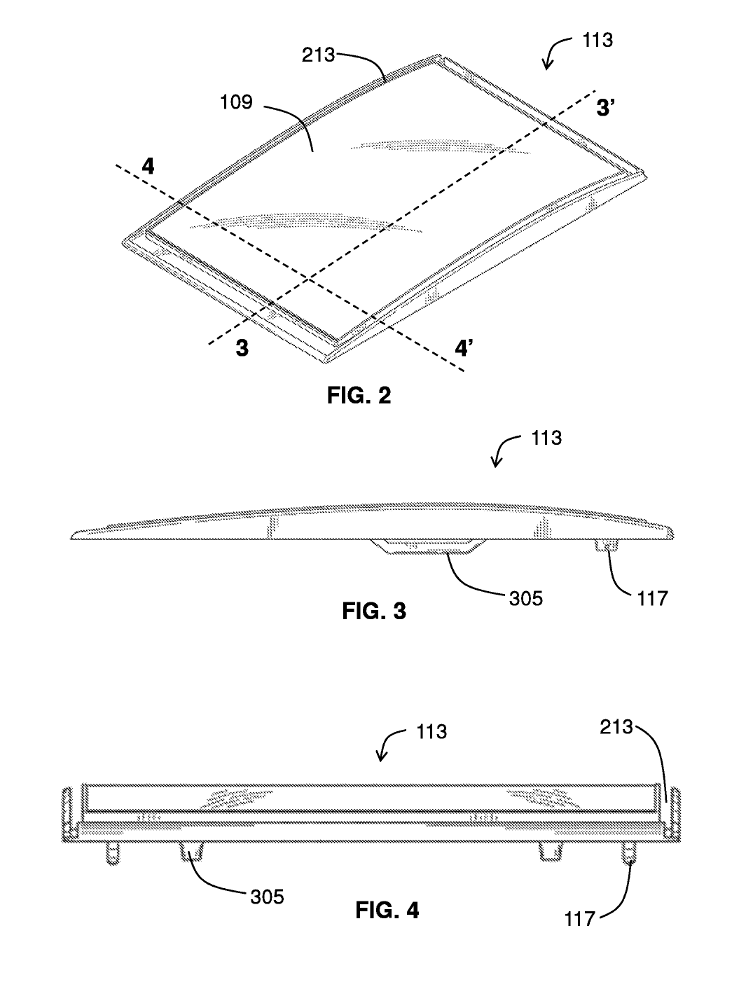

FIG. 2 depicts a roof member 113 for a solar golf car. A photovoltaic roof assembly includes a roof member 113 mountable to an electric vehicle, and a photovoltaic assembly including a PV cell 109 at the upper part of the roof. The photovoltaic assembly may be mounted to a separate roof surface or the photovoltaic assembly may itself constitute all or part of the roof. As shown in FIG. 2, the roof apparatus may include gutters 213. The roof may have mounting element recesses to accommodate mounting elements of the photovoltaic assembly, the mounting elements configured so as not to shade the photovoltaic panel. The roof may also be configured to accommodate a global positioning device. The roof preferably includes a peripheral gutter 213. The roof body preferably includes handhold recesses housing handhold elements 305 at positions to provide a horizontal setback from the lateral sides of the roof body. Roof member 113 connects to a golf car via support legs 121 (shown in FIG. 1). Additional discussion of photovoltaic cells suitable for modification for use with the invention may be found in U.S. Pat. No. 5,725,062 to Fronek and U.S. Pat. No. 6,702,370 to Shugar, the contents of each of which are incorporated by reference for all purposes.

The roof assembly may be mounted on top of upright supports 121 that attach to an electric vehicle. The upright supports 121 will have mounting points on the bottom attaching it to the 3 most common type of electric vehicles (Club Car, Yamaha, EZ-Go) but may also be customized to fit others. The front upright supports will be angled in a way that will slant towards the interior of the cart allowing rain to fall away from the passengers and lower the reflection of the sun. The uprights will house any wires that run from solar panel or controller down to the batteries keeping it housed and away from elements. The stylization of the roof system begins where the uprights connect to the cart itself. The windshield becomes part of the stylized element and organically blends into the roof creating a natural ergonomic curve shape.

The vertical uprights 121 may emerge from the cart at the designed locations for the most popular makes of golf cars. The uprights 121 transform into a stylized element that is part of the roof system. In doing this, the roof system including the uprights 121 will be able to maintain its distinct style even if the golf car manufacturer changes its mounting scheme on the cart. The benefit a golf course manager is that it won't be necessary to change any aspects of the roof itself should the mounting points of the uprights of the cart manufacturer change. A photovoltaic cell 109 on is disposed on a top surface of roof member 201.

FIG. 3 is a cross section of roof member 113 along line 3-3′ in FIG. 2. Roof member 113 includes bosses 117 to connect to support legs 121 to provide a lightweight solar roof with benefits that include a reduction in the amount of “grid charging” required to maintain a charge in the batteries for operation. The reduction in electricity costs benefit the bottom line of a golf course. Environmental impact of the golf course utilizing these systems is greatly reduced. Benefits include less strain on the energy grid, reduced air pollution, reduced water pollution, reduction in landfill disposal of toxic batteries.

FIG. 4 is a cross section of roof member 113 along line 4-4′ in FIG. 2. The solar apparatus may include other features such as rain gutters 213 to direct rain away from the photovoltaic cell 109 and occupants of the golf car. In some embodiments, the support legs 121 are configured to mate to pre-determined mounting points of a specified model of golf car.

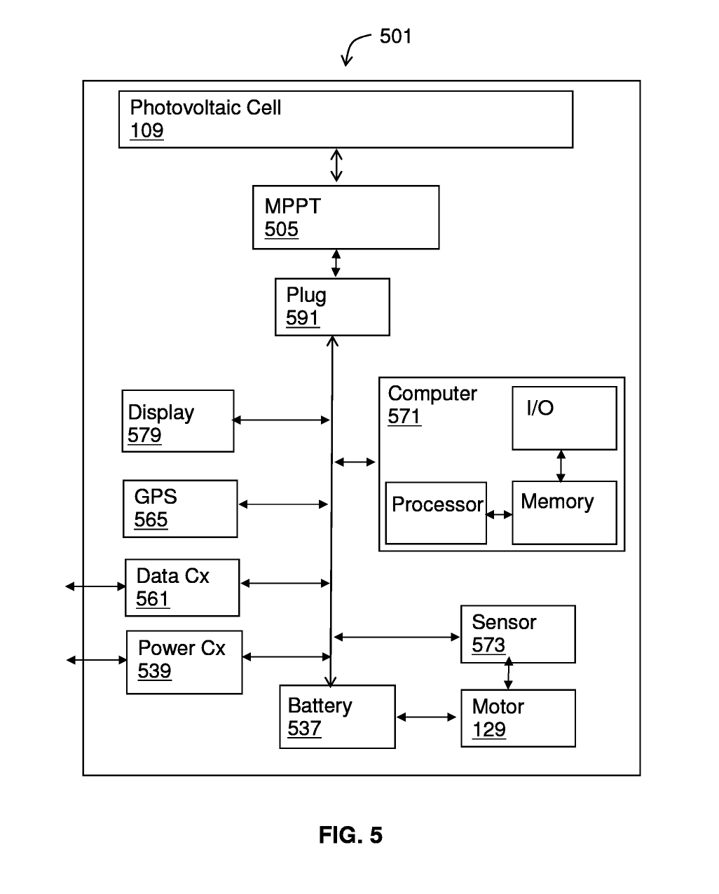

FIG. 5 is a diagram of components of controller system 501. Controller system 501 includes cell 109 and preferably includes one or more of a maximum power point tracking (MPPT) device 505, a motor 129, a cart battery 537, a power connection 539, a data connection 561, a positioning device 565, an electronic device 571, a display device 579, or any combination thereof. Plug 591 is an optional connection between electrical components on a detachable roof apparatus and electrical components on a golf car (e.g., motor 129 and battery 537). Power connection 539 allows the cart to plug into a charging station. Data connection 561 may be a USB jack. A sensor 573 can track revolutions of the wheels or function as an odometer.

System 501 preferably includes an MPPT device 505. The MPPT device 505 is used for its ability to capture changing voltage outputs from the solar panel 109. The nature of an electric golf vehicle dictates that it be used outdoors. By accepting current in low light conditions, shade, direct light conditions, fog etc. the MPPT device 505 may allow the owner of the vehicle to avoid charging the vehicle as much as a non-solar electric vehicle or a solar electric vehicle that doesn't use an MPPT device 505. The use of an MPPT device 505 may also allow the driver of the electric vehicle to avoid running out of charge while in use. The benefit is less customer anguish, lowering of labor costs in running a freshly charged cart out on the course and safety issues involved in having stranded golfers in the way of golf balls from behind.

The MPPT device 505 may be wired directly into roof member 113 and wires may extend laterally along the underside of the roof in a housed compartment and into the body of the vehicle and ultimately into the battery compartment. The benefit to this feature is the wiring harness is housed inside the upright 121 of the cart 101, which protects the wiring from weather and the possibility of being bumped when people are reaching for items in the cart or golf clubs.

MPPT device 505 may be installed within the apparatus between the photovoltaic cell 109 and the jack that connects the solar roof apparatus to the golf car. The apparatus can include for display 579 an “electricity gas gauge”—a gauge disposed on the apparatus and configured to be visible to a driver of the golf car when the apparatus is installed on the golf car. The gauge display 579 displays information about electrical power available to the golf car. Additionally helpful discussion may be found in U.S. Pub. 2011/0210693 to Reichart; U.S. Pub. 2008/0143292 to Ward; and U.S. Pub. 2013/0335002 to Moore, the contents of each of which are incorporated by reference for all purposes.

In certain embodiments, the apparatus will include a meter device (e.g., GPS device 565 or an odometer or a revolution counter) configured to measure a distance that the golf car has been driven. Other possible features include a USB port 561 to provide electricity to a device when the device is plugged into the USB port, an external jack 539 for making a connection to a charging station (to provide and receive electrical power through the connection), or both. The apparatus may include a processing unit 571 having stored therein information unique to at least one predetermined golf course and operable to limit output of motor 129 on the cart if the cart's usage at full speed will exceed an available amount of energy.

MPPT device 505 is a microcontroller based electronic device for charging the energy storage module (e.g. batteries) of a golf car from the roof mounted photovoltaic solar array. The device has features to maximize the utilization of the solar array, provide a “gas gauge” display of available energy, store a history of events and usage, and has a unique feature that interacts with the cart's motor controller to modulate the amount of power available to the cart driver to insure that enough energy is available to complete a round of golf.

The golf car has battery 537 typically made up of a number of batteries. These batteries are typically lead-acid chemistry, but could also be another battery chemistry or some other form of energy storage, all will be referred to as “battery”. The battery is to be charged via the solar array 109 and maximum power point tracking (MPPT) methods and devices are used to control power use. Specifically, a typical MPPT device 505 will include a DC to DC converter that matches output of panel 109 to load. The microcontroller has several algorithms that can be tailored for the type of battery and solar array to provide the most efficient use of the solar energy.

The device 505 monitors the energy flowing into the battery 537 and out to the motor 129. The capacity and characteristics of the battery 537 are known to the controller 505 and therefore a very accurate estimation can be made of the available energy. An analogy is the gas gauge on an automobile. The computation of available energy is a complex interaction of not only power in (from the solar array), power out (to the motor), but of the rate of energy use i.e. in most battery systems, the apparent amount of stored energy becomes smaller as the rate of consumption becomes higher. In lead-acid chemistry, for example, this relationship is defined by Peukert's Law. The microcontroller 505 is able to sample voltages and currents many times a second and calculate a complex formula and display on display 579 the results to the cart driver instantaneously. Further discussion of MPPT devices may be found in U.S. Pub. 2009/0160258 to Allen; U.S. Pub. 2011/0297459 to Hayek; U.S. Pub. 2014/0097669 to Nagashima; U.S. Pub. 2011/0163710 to Syed; U.S. Pub. 2011/0162897 to Syed; and U.S. Pat. No. 8,419,118 to Petersen, the contents of each of which are incorporated by reference.

The device stores a history of events and usage (e.g., either within MPPT device 505, computer 571, or both). This data is useful to the owners of the golf cars to understand such things as energy savings provided by the solar array, operations potentially damaging to the battery 537, usage in relation to required servicing, and operational information that can be used to fine tune and improve the operation of the cart in the future. The device uses some of this information internally to improve its MPPT algorithm and “gas gauge” function. System 501 can be programmed using ‘fuzzy logic’ algorithms known in the art so that the microcontroller based device can change its own programming to suit present conditions or ‘remember’ conditions and usage. Other information can be output to the cart's operator in the form of data that can be used for reporting and review.

The typical golf car is used on a fixed course whose size is known. The golf car traverses typically 18 holes of golf and the average distance traveled by the cart is known. A sensor 573 tracks the revolutions of the cart's wheels (alternately distance over ground may be computed from global position system (GPS) information) and the device is able to determine the distance traveled. At any given time there is a certain amount of stored energy available in the battery. The device computes the amount of distance required to complete the round of golf.

If the cart's usage at full speed will exceed the available amount of energy available, the device will limit the output of the cart's motor to be able to safely cover the distance needed for completion. The calculation is updated frequently to account for varying conditions. For example, a cart in full sunshine would provide maximum charge to battery 537 allowing robust operation of car 131. Should car 131 be under tree shade, or perhaps a cloudy day, the device will modulate the motor power to extend the range of the cart to allow completion of the round of golf. This will prevent golfers from becoming stranded on the course. The on-cart system may include a USB charging point.

Benefits to golfers using golf car 131 with the solar electric charging system include: a reduction in the possibility of the vehicle “dying” during operation. This benefit includes a faster pace of play, avoiding the frustration of having to switch carts (to a cart with fresh batteries) in the middle of a round and avoiding the safety hazard of becoming stranded on a golf course while other golfers are trying to play through.

Preferably the controller system is operable to compare present power use to the information about the power required and regulate the motor so that an amount of power remaining is at least as great as an anticipated amount of power required to complete the round of golf. The power management device may include a maximum power point tracking device, and regulating the motor can be done by limiting a maximum speed of the golf car.

The information about the power required can use an average distance travelled per typical round of golf. Present power use may be determined by tracking cumulative distance traveled in the round of golf at the golf course. The connection 539 with the external power system can provide power from the external system to the golf car and provide power from the golf car to the external system.

In some embodiments, the controller system has a communication device 561 operable to exchange data about the power system with a system management server computer. The system can include an “electricity gas gauge” 579—a display visible to a driver of the golf car that shows an amount of power remaining. The system may include a positioning device 565 (e.g., a GPS device or barcodes and readers on the course) on golf car 131 to provide information to the controller system showing a present location of the golf car.

In a preferred embodiment, the information about the power required stored in the controller system includes a digital map of the golf course. Golf car 131 includes, in computer memory, a map. Map can mean a digital representation of a spatial layout of the course, or it can mean a recorded plan of distances to be traveled optionally with heights to be ascended along golf car paths during a round of golf for that course (e.g., an elevation change map for the golf car route for that course). The system can include maps for different courses, with the appropriate map being called into use at any given course. Thus, in certain embodiments, the controller system has stored therein a plurality of maps of different golf courses that includes a map that represents the golf course, wherein the information about the power required indicates which map represents the golf course.

The power system may include a jack 561 (such as a USB port) on golf car 131 for providing power to a personal electronic device. Thus a golfer may charge their smartphone or use their tablet computer in the cart. Additionally or alternatively, the system may include a connection point 539 for making a connection with an external power system.

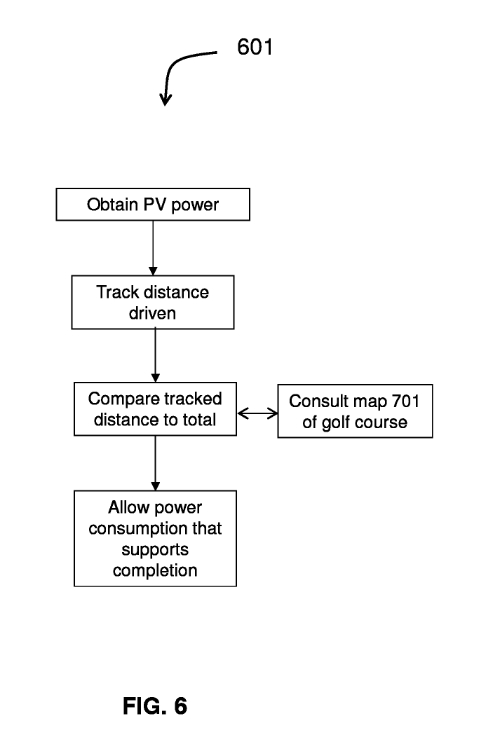

FIG. 6 diagrams a method 601 for managing power of a golf car 131. Power for a golf car is obtained during a round of golf at a predetermined golf course through the use of a photovoltaic power system on the golf car. The method includes tracking a distance driven by golf car 131 during the round of golf, comparing the tracked distance to an average total distance associated with the predetermined golf course using the power system on golf car 131; and regulating power consumption of the golf car, using the power system, so that the golf car will not run out of power until it has driven the average total distance. Preferably, the power system comprises one or more of a photovoltaic cell, a battery, a motor, a maximum point power tracking device, a processor, and a non-tangible computer-readable storage medium having stored therein information about the predetermined golf course.

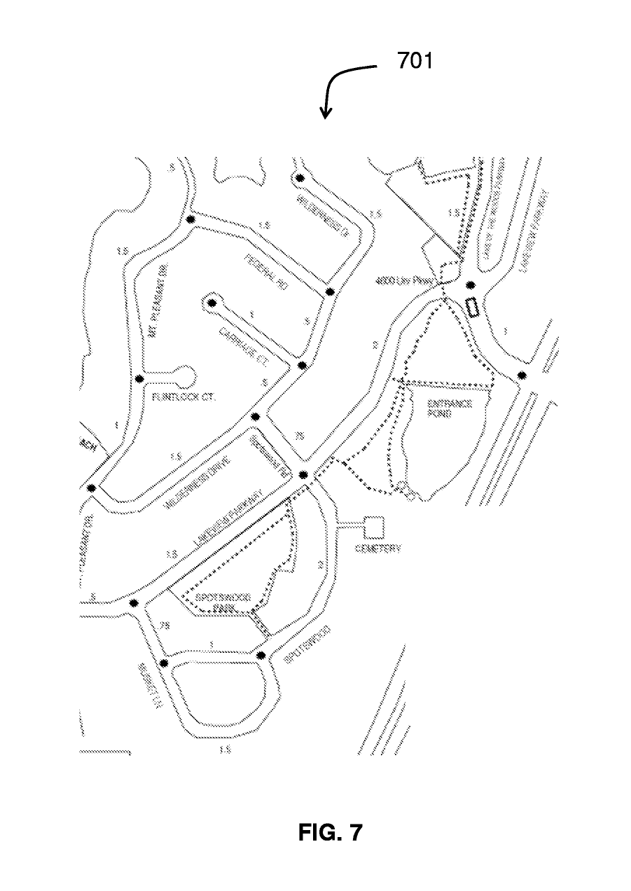

FIG. 7 depicts map 701 giving information about a predetermined golf course. While shown in FIG. 7 as a familiar, human-readable plan view map, map 701 may include GPS data points for a golf course, or a schedule of typical power consumption over time or space. An important feature of map 701 is that it is customized to a golf course and thus provides information unique to that golf course about power demands associated with that course. For instance, a golf course with steep hills can have a map 701 that tells system 501 that car 131 will use increased amounts of power at those hills.

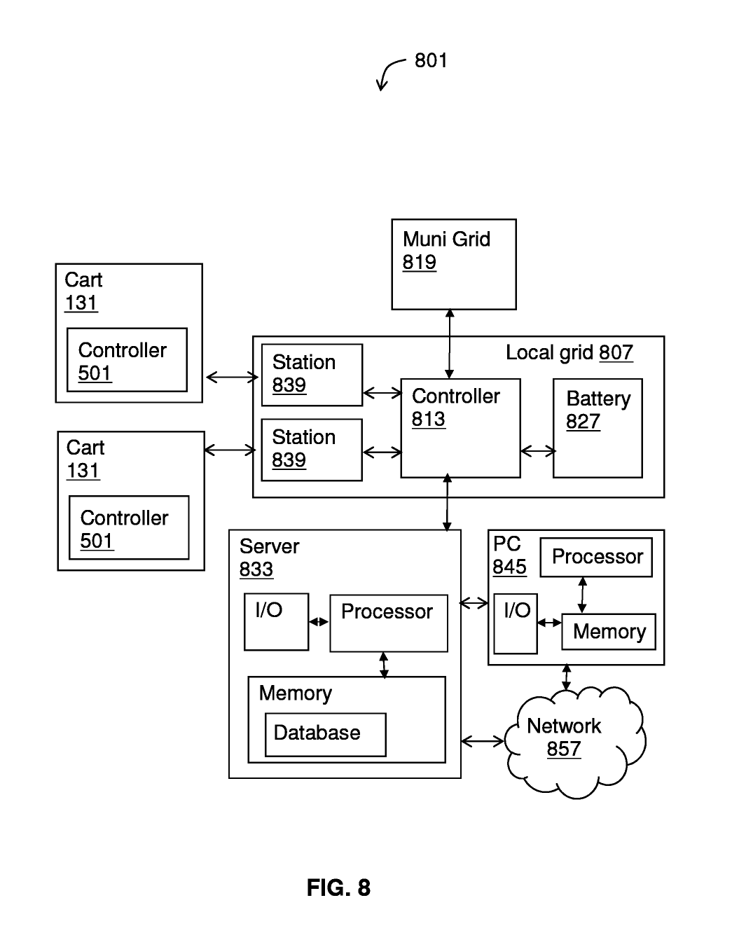

FIG. 8 shows a power management system 801 for a golf course. System 801 includes a local electrical grid system 801 installed at a golf course, which local grid has at least one connection to an external municipal power system 819, at least one battery system 827, and at least one charging station 839. System 801 includes golf cars 131 that each have a photovoltaic cell 109 and a jack 539 connectable to the charging station 839. Local grid 807 is controlled by controller 813 connected to charging station 839, battery 827, and also to an optional system management server computer 833. Server 833 can be accessed via computer 845 preferably installed at the golf course where local grid 807 is located. Computer 845 may communicate with server 833 via network 857. A system 801 of the invention includes infrastructure that is installed at a specific golf course. The installed infrastructure includes the local electrical grid 807, with its charging station 839 and battery 827. The local infrastructure also includes at least one computer 845 for interacting with system 801. Server 833 and components of network 857 need not be on-site and may be leased or paid for as a service. Discussion may be found in U.S. Pub 2009/0152947 to Wang; U.S. Pub. 2011/0031171 to Henig; U.S. Pat. No. 6,313,394 to Shugar and U.S. Pub. 2006/0127183 to Bishop, the contents of each of which are incorporated by reference.

Within system 801, preferably each golf car 131 includes a controller system 501 with a power management device, a computer having stored therein a map 701 describing the golf course, and a display showing power remaining. Noting again that map 701 need not be the familiar plan view drawing of a location and can instead refer to a schedule of typical power consumption, it is an important feature of system 801 that a golf car 131 includes a map 701 with information about the unique power demands of the golf course where local grid 807 is installed. The interaction of elements described herein is what allows a golf car 131 to be used on a golf course and to refer to map 701 to determine an anticipated power demand for that golf course and to display on display 579 an amount of power remaining or an amount of distance remaining, thus providing golf car 131 with an electricity gas gauge as well as a regulatory mechanism via MPPT device 505 to ensure that car 131 does not cease operation during a round of golf.

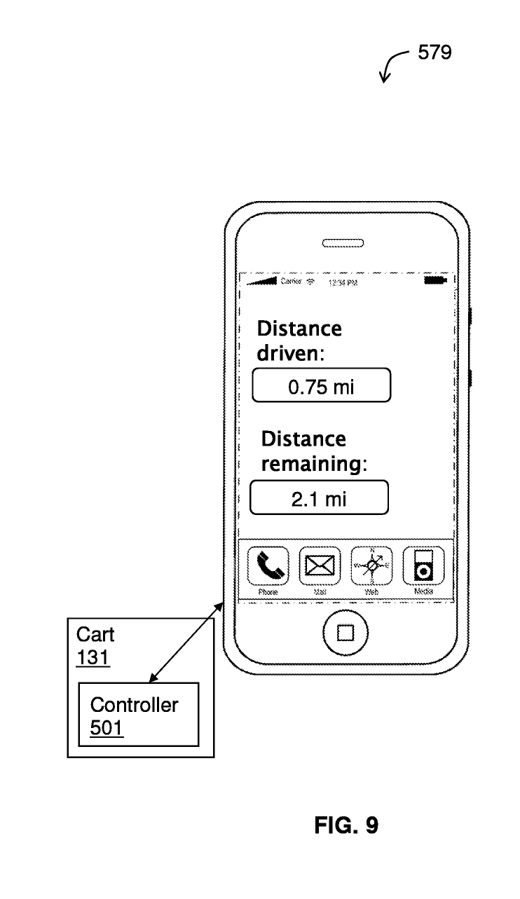

FIG. 9 shows one method and display device 579 for displaying an amount of power remaining Display device 579 communicates with control system 501 (e.g., via a wireless or a wired connection) on car 131. Controller system 501 uses the information unique to the golf course such as a map 701 and the power remaining to modulate power consumption. Each golf car 131 captures power via its photovoltaic cell, provides surplus power to the at least one battery system at a time when it is connected to the charging station and fully charged, and draws power from the at least battery system at a time when it is connected to the charging station and not fully charged. System 501 on car 131 communicates with system 801 for overall efficient power administration at the golf course. Specifically, system 801 can be administered from system management server computer 833. System management server computer 833 monitors power consumption in the golf cars 131.

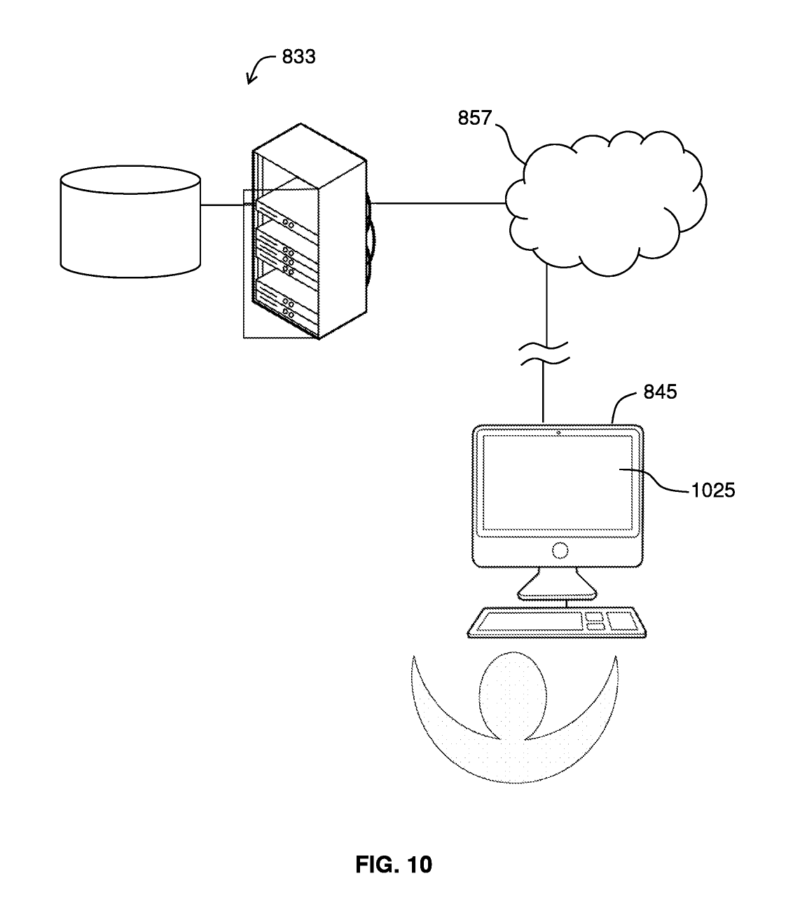

FIG. 10 illustrates a system administrator managing power at a golf course through the use of system 801. A system administrator uses terminal 845 to connect to server 833 via network 857. Terminal 845 presents a system management dashboard on interface 1025.

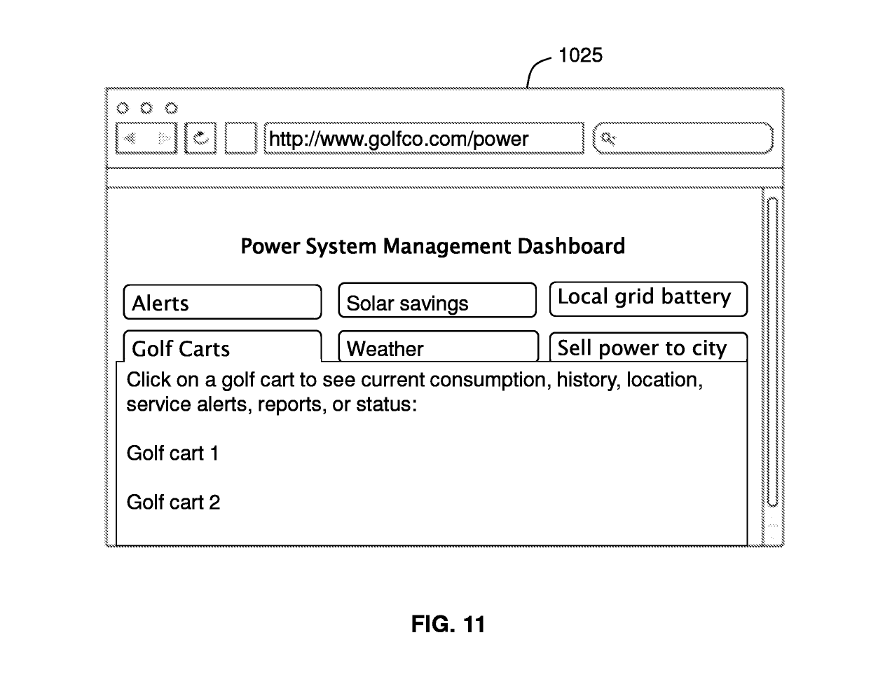

FIG. 11 illustrates interface 1025 for managing system 801. As discussed above, each golf car 101 has a controller system 501 that includes a power management device 505 electrically coupled to the cell 109; a processor; and a memory device having stored therein information unique to the golf course. The controller system 501 uses the information unique to the golf course to regulate power use so that the golf car 131 is operable for a duration of a round of golf on the golf course. The local electrical grid system 819 may be operable to provide surplus local grid 807 power to the external municipal power system 819 with the server computer 833 providing a statement of an amount of surplus local grid power provided to the external municipal power system 819.

Golf facilities utilizing these systems will experience a modern new look for their existing golf cars. This upgrade will help customers feel as if they are riding in a new modern vehicle without the cost of the facility having to replace the actual fleet of vehicles. Facilities can just replace their existing roof and uprights with the Solar roof system and enjoy a new fresh look and feel. With a modernized fleet of golf cars a golf facility is may attract more new and repeat customers, increasing revenue.

Sustainable energy is provided by a system 801. Over the past few years, corporate sustainability has become a priority issue for businesses of almost every kind and size. Corporate America now faces a wide range of sustainability-focused inquiries, demands, risks and challenges from customers, investors, regulators, consumers, NGOs and other watchdog groups, and even the media. The golf and hospitality industries are no exception—not only do they face tremendous pressure to cut costs due to the economic downturn (and resulting falling revenues) over the past several years but, to keep up with their competitors in the race to “go green,” they also must develop and implement meaningful sustainability plans. Solar-powered golf cars are a great way to help meet these challenges.

As shown in FIG. 5, golf car 131 may include a control system 501 with a computer 571. As shown in FIG. 8, system 801 includes a server 833, a PC 845, or both. Additionally, controller 813 may optionally include a dedicated computer. MPPT 505 may include elements characteristic of a computer. Further, in some embodiments, display 579 is provided by a mobile electronic device such as a smartphone or tablet which may itself be a computer.

A computer according to the invention will generally include one or more processors and memory as well as an input/output mechanism (I/O). Where methods of the invention employ a connected computer devices, steps of methods of the invention may be performed using multiple computing devices working together as a system. For example, server 833, which includes one or more of processors and memory, may obtain data, instructions, etc., or provide results via an interface module or provide results as a file. The server 833 may be engaged over the network 857 by the computer 845 or the display 579, or the server 333 may be directly connected to the computer 845, which can include one or more processors and memory, as well as an input/output mechanism.

In systems of the invention, each computer preferably includes at least one processor coupled to a memory and at least one input/output (I/O) mechanism.

A processor will generally include a chip, such as a single core or multi-core chip, to provide a central processing unit (CPU). A processer may be provided by a chip from Intel or AMD.

Memory can include one or more machine-readable devices on which is stored one or more sets of instructions (e.g., software) which, when executed by the processor(s) of any one of the disclosed computers can accomplish some or all of the methodologies or functions described herein. The software may also reside, completely or at least partially, within the main memory and/or within the processor during execution thereof by the computer system. Preferably, each computer includes a non-transitory memory such as a solid-state drive, flash drive, disk drive, hard drive, etc. While the machine-readable devices can in an exemplary embodiment be a single medium, the term “machine-readable device” should be taken to include a single medium or multiple media (e.g., a centralized or distributed database, and/or associated caches and servers) that store the one or more sets of instructions and/or data. These terms shall also be taken to include any medium or media that are capable of storing, encoding, or holding a set of instructions for execution by the machine and that cause the machine to perform any one or more of the methodologies of the present invention. These terms shall accordingly be taken to include, but not be limited to one or more solid-state memories (e.g., subscriber identity module (SIM) card, secure digital card (SD card), micro SD card, or solid-state drive (SSD)), optical and magnetic media, and/or any other tangible storage medium or media.

A computer of the invention will generally include one or more I/O device such as, for example, one or more of a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

Any of the software can be physically located at various positions, including being distributed such that portions of the functions are implemented at different physical locations.

Systems of the invention may be used to perform methods described herein. Instructions for any method step may be stored in memory and a processor may execute those instructions.

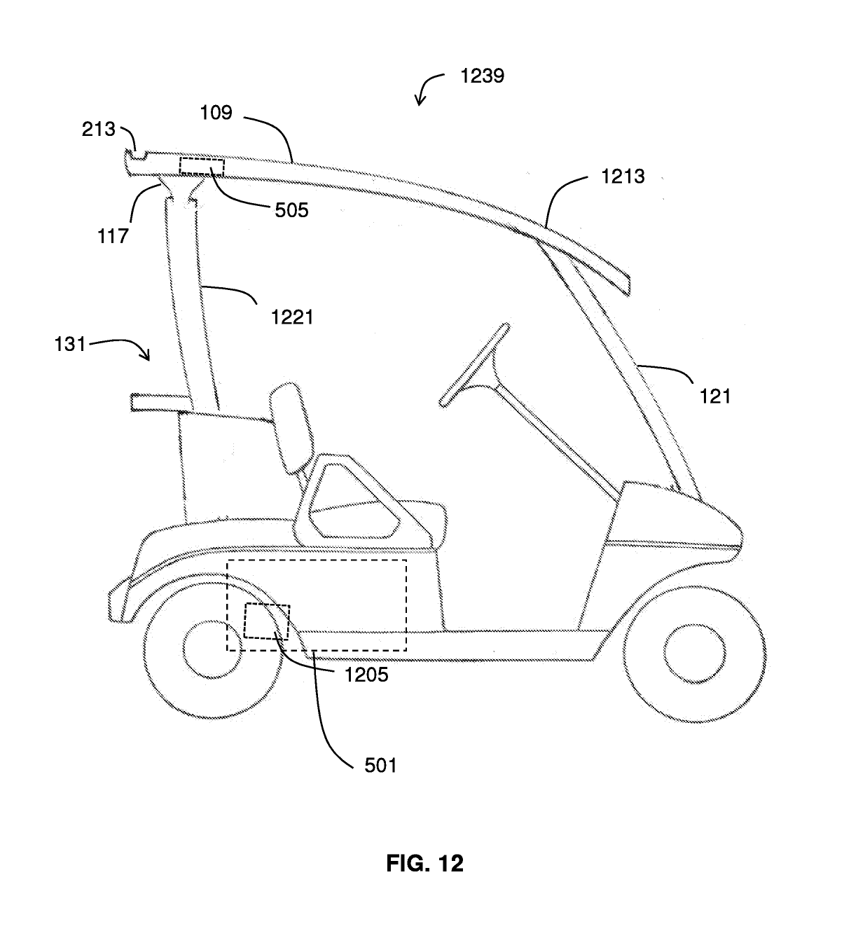

FIG. 12 depicts a golf car 131 with a solar roof apparatus 1213 according to a preferred embodiment. Golf car 131 is made available for use at a golf course with a photovoltaic cell 109 mounted on a roof member 1213 of the golf car supported by uprights 1221. Roof member 1213 with cell 109 defines a solar apparatus 1239 provided as a standalone apparatus 1239 (optionally with or without support uprights 1221 connected via support bosses). Apparatus 1239 is a solar roof installable onto golf car 131 and may include gutters 2213.

The roof may have mounting element recesses to accommodate mounting elements of the photovoltaic assembly, the mounting elements configured so as not to shade the photovoltaic panel. The roof may also be configured to accommodate a global positioning device. The roof preferably includes a peripheral gutter 2213. The roof body preferably includes handhold recesses housing handhold elements at positions to provide a horizontal setback from the lateral sides of the roof body.

Roof member 1213 connects to a golf car via support legs 1221. Additional discussion of photovoltaic cells suitable for modification for use with the invention may be found in U.S. Pat. No. 5,725,062 to Fronek and U.S. Pat. No. 6,702,370 to Shugar, the contents of each of which are incorporated by reference for all purposes.

A photovoltaic (PV) roof assembly 1239 includes a roof mountable to an electric vehicle, and a PV assembly 109 at the upper part of the roof. The PV assembly 109 may be mounted to a separate roof surface or the PV assembly may itself constitute all or part of the roof. The roof 1239 may have mounting element recesses to accommodate mounting elements of the PV assembly, the mounting elements configured so as not to shade the PV panel. The roof may also be configured to accommodate a global positioning device. The roof preferably includes a peripheral gutter 213. The roof body 1213 preferably includes hand-hold recesses housing hand-hold elements at positions to provide a horizontal setback from the lateral sides of the roof body.

The roof assembly 1239 may be mounted on top of upright supports 1221 which attach to an electric vehicle 131. The upright supports 1221 will have mounting points on the bottom attaching it to common type of electric vehicles (Club Car, Yamaha, EZ-Go) but may also be customized to fit others. Roof assembly 1239 may include gutter(s) 213. The front upright supports 1221 will be angled in a way that will slant towards the interior of the cart allowing rain to fall away from the passengers and lower the reflection of the sun as shown in FIG. 12. The uprights will house any wires that run from solar panel or controller down to the batteries keeping it housed and away from elements. An MPPT controller 505 is used for its ability to capture changing voltage outputs from the solar panel 109. The nature of an electric golf vehicle 131 dictates that it be used outdoors. By accepting current in varying light conditions such as a shade, fog, and direct sunlight, the MPPT controller may allow the owner of the vehicle to avoid charging the vehicle as much as a non-solar electric vehicle or a solar electric vehicle that doesn't use an MPPT controller. The use of an MPPT controller may also allow the driver of the electric vehicle to avoid running out of charge while in use. The benefit is less customer anguish, lowering of labor costs in running a freshly charged cart out on the course and safety issues involved in having stranded golfers in the way of golf balls from behind.

The stylization of the roof system begins where the uprights 1221 connect to the cart 131 itself. The windshield becomes part of the stylized element and organically blends into the roof creating a natural ergonomic curve shape.

The MPPT solar controller 505 is wired directly into the solar panel 109 and wires extend laterally along the underside of the roof in a housed compartment and into the body of the vehicle and ultimately into the battery compartment. The benefit to this feature is the wiring harness is housed inside the upright of the cart which protects it from weather and the possibility of being bumped when people are reaching for items in the cart or golf clubs.

Thus it can be seen that roof assembly 1239 provides a light weight vehicles solar electric roof with benefits that include a reduction in the amount of grid charging required to maintain a charge in the batteries for operation. The reduction in electricity costs benefit the owners bottom line. Environmental impact of a facility utilizing these systems is greatly reduced. Benefits include less strain on the energy grid, reduced air pollution, reduced water pollution, reduction in land fill disposal of toxic batteries. Benefits to customers visiting/renting vehicle with solar electric charging system include: a reduction in the possibility of the vehicle “dying” during operation. This benefit includes a faster pace of play, avoiding the frustration of having to switch carts (to a cart with fresh batteries) in the middle of a round and avoiding the safety hazard of becoming stranded on a golf course while other golfers are trying to play through. Golf facilities utilizing these systems will experience a modern new look for their existing golf carts. This upgrade will help customers feel as if they are riding in a new modern vehicle without the cost of the facility having to replace the actual fleet of vehicles. Facilities can just replace their existing roof and uprights with roof assembly 1239 and enjoy a new fresh look and feel. With a modernized fleet of golf cars 131 a golf facility is may increase green fees helping its bottom line. The vertical uprights 1221 will emerge from the cart 131 at the designed locations for the most popular makes of golf carts. The uprights transform into a stylized element that is part of the roof system. In doing this, the roof system including the uprights 1221 will be able to maintain its distinct style even if the golf cart manufacturer changes its mounting scheme on the cart. The benefit include that it is not necessary to change any aspects of the roof itself should the mounting points of the uprights of the cart manufacturer change.

A microcontroller based electronic device 505 for charging the energy storage module (e.g. batteries) of a golf cart 131 from the roof mounted photo voltaic solar array 1239. The device has features to maximize the utilization of the solar array, provide a “gas gauge” display of available energy, store a history of events and usage, and has a unique feature that interacts with the cart's motor controller to modulate the amount of power available to the cart driver to insure that enough energy is available to complete a round of golf.

The golf cart has an energy storage module typically made up of a number of batteries. These batteries are typically lead-acid chemistry, but could also be another battery chemistry or some other form of energy storage, all will be referred to as “battery”. The battery is to be charged via the solar array. MPPT device 505 has several algorithms that can be tailored for the type of battery and solar array to provide the most efficient use of the solar energy.

The device 505 monitors the energy flowing into the battery and out to the motor. The capacity and characteristics of the battery are known to the controller and therefore a very accurate estimation can be made of the available energy. An analogy is the gas gauge on an automobile. The computation of available energy is a complex interaction of not only power in (from the solar array), power out (to the motor), but of the rate of energy use i.e. in most battery systems, the apparent amount of stored energy becomes smaller as the rate of consumption becomes higher. In lead-acid chemistry, for example, this relationship is defined by Peukert's Law. The microcontroller is able to sample voltages and currents many times a second and calculate a complex formula and display the results to the cart driver instantaneously.

The device 505 stores a history of events and usage. This data is useful to the owners of the golf cart(s) to understand such things as energy savings provided by the solar array, operations potentially damaging to the battery, usage in relation to required servicing, and operational information that can be used to fine tune and improve the operation of the cart in the future. The device 505 uses some of this information internally to improve its MPPT algorithm and “gas gauge” function. Other information can be output to the cart's operator in the form of data that can be used for reporting and review.

The typical golf car 131 is used on a fixed course whose size is known. The golf car traverses typically 18 holes of golf and the average distance traveled by the cart is known. A sensor 1205 tracks the revolutions of the cart's wheels (alternately distance over ground may be computed from global position system (GPS) information) and the device 505 is able to determine the distance traveled. At any given time there is a certain amount of stored energy available in the battery. The device 505 computes the amount of distance required to complete the round of golf. If the cart's usage at full speed will exceed the available amount of energy available, the device will limit the output of the cart's motor to be able to safely cover the distance needed for completion. The calculation is updated frequently to account for varying conditions. For example, a cart in full sunshine would provide maximum charge to the battery allowing robust operation of the cart. Should the cart be under tree shade, or perhaps a cloudy day, the device 505 will modulate the motor power to extend the range of the cart to allow completion of the round of golf. This will prevent golfers from becoming stranded on the course.

Assembly 1239 may include features such as a charging point (e.g., USB); storage (e.g., phone pocket; rain gutters; handles; others; or any combination thereof.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A golf car power system comprising:
a golf car made available for use at a golf course;
a photovoltaic cell mounted on the golf car;
a controller system comprising a power management device electrically coupled to the cell and a processor coupled to a non-transitory memory and having stored therein information about power required for the golf car to operate for a duration of a round of golf at the golf course; and
a motor to drive the golf car.

2. The system of claim 1, wherein the controller system is operable to compare present power use to the information about the power required and regulate the motor so that an amount of power remaining is at least as great as an anticipated amount of power required to complete the round of golf.

3. The system of claim 2, wherein the power management device comprises a maximum power point tracking device, and wherein regulating the motor includes limiting power consumption of the golf car.

4. The system of claim 3, wherein the information about the power required comprises an average distance travelled per typical round of golf, and wherein present power use is determined by tracking cumulative distance traveled in the round of golf at the golf course.

5. The system of claim 4, wherein the connection with the external power system can provide power from the external system to the golf car and provide power from the golf car to the external system.

6. The system of claim 1, wherein the controller system comprises a communication device operable to exchange data about the power system with a system management server computer.

7. The system of claim 1, further comprising a display device operable to show an amount of power remaining.

8. The system of claim 1, further comprising a positioning device on the golf car operable to provide information to the controller system showing a present location of the golf car.

9. The system of claim 8, wherein the information about the power required stored in the controller system includes a digital map of the golf course.

10. The system of claim 1, wherein the controller system has stored therein a plurality of maps of different golf courses that includes a map that represents the golf course, wherein the information about the power required indicates which map represents the golf course.

11. The system of claim 1, further comprising a power jack on the golf car for providing power to a personal electronic device.

12. The system of claim 1, further comprising a connection point for making a connection with an external power system.

13. A power management method for a golf car, the method comprising:
obtaining power for a golf car during a round of golf at a predetermined golf course through the use of a photovoltaic power system on the golf car:
tracking a distance driven by the golf car during the round of golf;
comparing the tracked distance to an average total distance associated with the predetermined golf course using the power system on the golf car; and
regulating power consumption of the golf car, using the power system, so that the golf car will not run out of power until it has driven the average total distance.

14. The method of claim 13, wherein the power system comprises: a photovoltaic cell, a battery, a motor, a maximum point power tracking device, a processor, and a non-tangible computer-readable storage medium having stored therein information about the predetermined golf course.

15. The method of claim 13, further comprising providing surplus power from the golf car to a local grid at the predetermined golf course.

16. The method of claim 13, further comprising displaying an amount of power remaining via a display gauge.

17. A power management system for a golf course, the system comprising:
a local electrical grid system installed at a golf course and comprising at least one connection to an external municipal power system, at least one battery system, and at least one charging station;
a plurality of golf cars, each comprising a photovoltaic cell and a jack connectable to the charging station;
a system management server computer comprising a processor coupled to a non-transitory memory device containing instructions executable by the processer to cause the server computer to monitor power consumption in the plurality of golf cars,
wherein each of the plurality of golf cars captures power via its photovoltaic cell, provides surplus power to the at least one battery system at a time when it is connected to the charging station and fully charged, and draws power from the at least battery system at a time when it is connected to the charging station and not fully charged.

18. The system of claim 17, wherein each golf car comprises a controller system comprising a power management device electrically coupled to the cell; a processor; and a memory device having stored therein information unique to the golf course, wherein the controller system uses the information unique to the golf course to regulate power use so that the golf car is operable for a duration of a round of golf on the golf course.

19. The system of claim 17, wherein the local electrical grid system is operable to provide surplus local grid power to the external municipal power system and the server computer is operable to provide a statement of an amount of surplus local grid power provided to the external municipal power system.

20. The system of claim 17, wherein each golf car comprises a controller system comprising a power management device, a computer having stored therein information unique to the golf course, and a display showing power remaining, wherein the controller system uses the information unique to the golf course and the power remaining to modulate power consumption.

21. A solar apparatus for a golf car, the apparatus comprising:
a roof member with support legs for connection to a golf car;
a photovoltaic cell on a top surface of the roof member; and
a connection jack to electrically connect the photovoltaic cell to an electrical system of the golf car.

22. The apparatus of claim 21, further comprising rain gutters to direct rain away from the photovoltaic cell and occupants of the golf car.

23. The apparatus of claim 21, wherein the support legs are configured to mate to pre-determined mounting points of a specified model of golf car.

24. The apparatus of claim 21, further comprising a maximum power point tracking device installed within the apparatus between the photovoltaic cell and the connection jack.

25. The apparatus of claim 24, further comprising a gauge disposed on the apparatus and configured to display information about electrical power available to the golf car.

26. The apparatus of claim 24, further comprising a meter device configured to measure a distance that the golf car has been driven.

27. The apparatus of claim 21, further comprising at least one USB port to provide electricity to a device when the device is plugged into the USB port.

28. The apparatus of claim 21, further comprising an external jack for making a connection to a charging station, and operable to provide and receive electrical power through the connection.

29. The apparatus of claim 21, further comprising a computer having stored therein information unique to at least one predetermined golf course and operable to limit output of a motor on the cart if the cart's usage at full speed will exceed an available amount of energy.
